(19) United States
(12) Patent Application Publication
(10) Pub. No.: US 2023/0190021 A1
(43) Pub. Date: Jun. 22, 2023

(54) Improved Drinking Straws and Manufacturing Process

(71) Applicants: Francis Morris Goodman, Jr., Dallas, TX (US); Christina Frances Faraone, Dallas, TX (US)

(72) Inventors: Francis Morris Goodman, Jr., Dallas, TX (US); Christina Frances Faraone, Dallas, TX (US)

(21) Appl. No.: 17/926,938

(22) PCT Filed: Jun. 2, 2020
(86) PCT No.: PCT/US2020/035710

§ 371 Date: Nov. 21, 2022

(51) Int. Cl. A47G 21/18; B31D 5/00; A61C 15/04

(52) U.S. Cl. CPC A47G 21/18; A47G 21/183; B31D 5/0095; A61C 15/041; A61C 2202/00

(57) ABSTRACT

Provided are improved drinking straws comprising an integrated device providing an anti-outflow capability, methods for their use, and processes for their manufacture. Specifically, the drinking straw is formed substantially of a cellulosic material and wherein the drinking straw and the device providing the anti-outflow capability comprising a flexible flap having a fixed end affixed to an interior surface of a sidewall of the drinking straw, and a part of the flexible flap obscuring an inlet orifice passing through the sidewall adjacent to the flexible flap and forming a liquid tight seal when a reduced pressure condition exists within the interior flow passage of the drinking straw.

### CROSS-REFERENCE TO RELATED DOCUMENTS

The present invention claims priority to, and is a national entry from PCT/US2020/035710 filed on Jun. 2, 2020, disclosure of which is included herein at least by reference.

### FIELD OF THE INVENTION

The present invention relates to improved drinking straws, methods for their use and processes for their manufacture.

### DISCUSSION OF THE STATE OF THE ART

Drinking straws are ubiquitous, and are enjoyed by most persons as providing a convenient and sanitary way to withdraw a beverage from a container, such as by using a single-use disposable type straw and drinking a liquid contained in a can, bottle, jar or other container. However, certain individuals have reduced ability to maintain suction while drawing upon a straw inserted into a liquid, such as a beverage. This may result from a physiological issue or illness, or also may be encountered with individuals needing to avoid air in their system following certain types of surgeries. Separately from the foregoing, recent growing environmental concerns regarding the manufacture and more pertinently, disposal of certain nonbiodegradable single-use products including well-known plastic or polymer drinking straws of the single-use variety is of ever-increasing consideration to manufacturers, and to consumers. Thus, there is a need in the arts to address these foregoing issues and concerns.

In the prior art, drinking straws having an anti-outflow capability have been provided by the use of drinking straw articles having incorporated into their construction, or added thereto, a check-valve. In a simple form, such a check-valve feature is disclosed in a prior application filed by the present inventor, namely U.S. Pat. No. D332,198. While such if proven to be highly effective, limitations on such a check-valve are numerous. For example, they require as is a minimum some type of a valve, which is frequently comprised of at least two elements which interoperate to block the outflow of a liquid from within the interior of the drinking straw. A very common example is that of a transverse element to which extends across the interior diameter of the drinking straw, which has a passage extending therethrough to provide for liquid flow, which interoperates with a second, separate movable element, typically a ball, which under the influence of liquid pressure exerted thereon acts to mechanically force the second movable element to form a substantially liquid tight seal with the transverse element. In the simplest embodiment, the transverse element includes a generally circular perforation, optionally having an upper edge of which is profiled to form a liquid tight, or at least a flow restricting seal when this perforation is stoppered by a suitably sized and correspondingly dimensioned ball. While such has proven effective, the factor of such requires the insertion of the separate parts, typically after the production of the drinking straw. A further concern is the mobility of the second movable element particularly when it is detached from the transverse element, or any other part of the straw; such mobility may occasion the loss of the second movable element thus defeating the operability of the drinking straw or, in an unwanted scenario, a user of such a straw may inadvertently swallow the second movable element. This has been addressed in various manners, a simple solution being that of the provision of a third perforated element also transverse to the inner diameter of the straw, which functions as a screen which on the one hand permits for the withdrawal of liquid from the bottom of the straw by means of suction, but on the other hand denies the removal of the second movable element from the interior diameter of the straw. Such is illustrated for example in U.S. Pat. No. D332,198.

The growing environmental concerns also have limited utility of such prior art devices to previously formed, rigid drinking straws which have sufficient structural stability after they are produced to allow for their subsequent mechanical handling and insertion of additional elements, such as check-valve elements and components thereof into the interior diameter of a drinking straw. However the majority of such rigid drinking straws are produced from non-biodegradable synthetic polymer materials which while permitting for the easy formation of such drinking straws, also is undesirable from a consumer standpoint in that they necessarily occupy landfills for an indefinite period of time.

Also known to the yard are straws which are formed from cellulosic materials, typically containing a high quantity of cellulose such as paper; such are much more attractive from a consumer standpoint from the perspective of biodegradability post use. As the vast majority of drinking straws are packaged and are intended to be of the single-use variety, is that is to say that they are providing a unitary package material, which may be a plastics, or a paper sleeve which is breached to permit for the subsequent withdrawal of a single drinking straw, which is then used to imbibe a liquid composition, typically a beverage, from a container, in view of such environmental concerns the ultimate substitution of polymer drinking straws with more environmentally friendly paper drinking straws is desired. However, such paper drinking straws are typically formed in a manner quite different from the polymer-based counterparts; in the case of the latter a polymer melt is extruded through a suitable die, forming an endless tube which is cut to desired lengths to thereby provide polymer drinking straws; while in the former a continuous ribbon of a paper, usually having an adhesive on a part thereof is spirally wound upon a rotating mandrel to form an endless tube which is subsequently cut into discrete sections to provide individual paper drinking straws. However, the reduced structural rigidity of such paper drinking straws defeats utility of many prior art devices providing an anti-outflow capability, i.e., a check-valve as such are typically comprised of one or more discrete elements which need to be subsequently inserted into the interior of a straw by mechanical operation which in the case of a paper drinking straw may be difficult due to the more fragile nature of the walls of a paper straw. Also, many such prior art devices providing an anti-outflow capability are themselves formed of non-biodegradable materials of construction thus effectively diminishing the environmental benefits of the use of paper drinking straws.

The present invention has addressed and solved many of these issues in a novel and unobvious manner.

### BRIEF SUMMARY OF THE INVENTION

In a first aspect the present invention provides a drinking straw providing an anti-outflow capability, preferably wherein in the drinking straw is formed substantially of a cellulosic material such as paper, and wherein the drinking straw and the device providing an anti-outflow capability is formed using, preferably is formed entirely of, environmentally friendly or biodegradable materials of construction.

In a second aspect the present invention provides a device providing an anti-outflow capability which can be integrated into a drinking straw during the manufacturing operation thereof, preferably wherein the drinking straw is a paper drinking straw, and wherein the drinking straw and the device providing an anti-outflow capability is formed using, preferably is formed entirely of, environmentally friendly or biodegradable materials of construction.

In a third aspect of the invention there is provided a method forming a drinking straw, which includes a device providing an anti-outflow capability, wherein the drinking straw and the device is formed using, but preferably is formed entirely of, environmentally friendly or biodegradable materials of construction.

In a fourth aspect of the invention there is provided a method facilitating the drinking of a liquid from a container, comprising the use of a drinking straw according to one or more further aspects of the invention described herein which the drinking straw includes a device providing an anti-outflow capability, wherein the drinking straw and the device is formed using, but preferably is formed entirely of, environmentally friendly or biodegradable materials of construction.

According to a fifth aspect, there is provided drinking straw providing an anti-outflow capability, wherein in the drinking straw is formed substantially of a cellulosic material and wherein the drinking straw and the device providing the anti-outflow capability is formed using environmentally friendly or biodegradable materials of construction.

According to a sixth aspect, there is provided drinking straw providing an anti-outflow capability, wherein in the drinking straw is formed substantially of a cellulosic material and wherein the drinking straw and the device providing the anti-outflow capability is formed using environmentally friendly or biodegradable materials of construction, wherein the device providing the anti-outflow capability is a flexible flap having a fixed end affixed to an interior surface of a sidewall of the drinking straw, and a part of the flexible flap obscuring an inlet orifice passing through the sidewall adjacent to the flexible flap and forming a liquid tight seal when a reduced pressure condition exists within the interior flow passage of the drinking straw.

According to a sixth aspect, there is provided drinking straw providing an anti-outflow capability, wherein in the drinking straw is formed substantially of a cellulosic material and wherein the drinking straw and the device providing the anti-outflow capability is formed using environmentally friendly or biodegradable materials of construction, wherein the device providing the anti-outflow capability is a plug having a flexible flap, the plug inserted in an inlet end of the drinking straw and forming a liquid tight seal therewith, the flexible flap having a part obscuring an inlet orifice passing through the sidewall adjacent to the flexible flap and forming a liquid tight seal when a reduced pressure condition exists within the interior flow passage of the drinking straw.

According to a seventh aspect, there is provided drinking straw providing an anti-outflow capability, wherein in the drinking straw is formed substantially of a cellulosic material and wherein the drinking straw and the device providing the anti-outflow capability is formed using environmentally friendly or biodegradable materials of construction, wherein the device providing the anti-outflow capability is a crimp at the inlet end of the drinking straw having depending therefrom a flexible flap, the crimp forming a liquid tight seal at the inlet end of the straw, the flexible flap having a part obscuring an inlet orifice passing through the sidewall adjacent to the flexible flap and forming a liquid tight seal when a reduced pressure condition exists within the interior flow passage of the drinking straw.

According to an eighth aspect, the invention provides a method of forming a drinking straw providing an anti-outflow capability, wherein in the drinking straw is formed substantially of a cellulosic material and wherein the drinking straw and the device providing the anti-outflow capability is formed using environmentally friendly or biodegradable materials of construction, the method comprising the steps of: providing a perforation through a paper tape; providing a flap to the paper tape in the proximity of the perforation; bonding the flap to the paper tape (optionally via a crimp) such that, in use, a portion of the flexible flap obscures the perforation of the drinking straw formed from the paper tape.

A ninth aspect of the invention is a method of forming a drinking straw providing an anti-outflow capability, wherein in the drinking straw is formed substantially of a cellulosic material and wherein the drinking straw and the device providing the anti-outflow capability is formed using environmentally friendly or biodegradable materials of construction, the method comprising the steps of: providing a perforation through a paper tape; forming a drinking straw from the paper tape such that the perforation is in the region of an inlet end, inserting a plug having a depending flexible flap into the inlet end such that, in use, a portion of the flexible flap obscures the perforation of the drinking straw formed from the paper tape.

A tenth aspect of the invention is a forming a drinking straw providing an anti-outflow capability, wherein in the drinking straw is formed substantially of a cellulosic material and wherein the drinking straw and the device providing the anti-outflow capability is formed using environmentally friendly or biodegradable materials of construction, the method comprising the steps of: providing a perforation through a first paper tape; forming a detachable flexible flap from a second tape; providing the flexible flap to the first paper tape such that a part of the flexible flap obscures the perforation; bonding a portion of the flexible flap to the first paper tape in the region adjacent to the perforation; optionally removing the second tape from the first paper tape, and separating the bonded flexible flap from the second tape; forming the drinking straw from the first paper tape and optionally the second paper tape. In an embodiment of this method, the second tape is separated from the first paper tape and from the bonded flexible flap, prior to formation of the drinking straw.

An eleventh aspect of the invention provides a drinking straw having an anti-outflow capability, wherein in the drinking straw is formed substantially of a cellulosic material and wherein the drinking straw and the device providing the anti-outflow capability is formed using environmentally friendly or biodegradable materials of construction, which further comprises an ingestible composition. The ingestible composition may be in the form of a pre-formed body of the ingestible composition. The ingestible composition may be a material which provides a nutritious, flavoring, medical, therapeutic, or other organoleptic perception or benefit to a person utilizing the straw. The ingestible composition may be one or more of: pharmaceutical preparations, nutraceutical preparations, confectionery compositions, natural sweeteners, artificial sweeteners, and flavoring compositions.

A further aspect of the invention is a breachable package containing a drinking straw having an anti-outflow capability, wherein in the drinking straw is formed substantially of a cellulosic material and wherein the drinking straw and the device providing the anti-outflow capability and a length of dental floss.

Further aspects are recited in one or more of the claims provided herein.

The drinking straws of the invention most preferably exclude ball and seat type valves, or check valves with moveable elements which are detached from or which are operable when not affixed to a part of the straw.

These and further aspects of the invention will become more apparent from a consideration of the following specification, and the accompanying drawings.

### BRIEF DESCRIPTION OF THE SEVERAL VIEWS OF THE DRAWINGS

FIG. 1 illustrates a side view of a first embodiment of a drinking straw according to the present invention, which includes an integrated device providing an anti-outflow capability.

FIG. 1A illustrates a partial view of FIG. 1, namely a first embodiment of a device providing an anti-outflow capability has been integrated into the drinking straw of FIG. 1.

FIG. 1B illustrates a partial view of FIG. 1, namely a second embodiment of a device providing an anti-outflow capability has been integrated into the drinking straw of FIG. 1.

FIG. 1C illustrates a partial view of FIG. 1, namely a third embodiment of a device providing an anti-outflow capability has been integrated into the drinking straw of FIG. 1.

FIG. 2 illustrates a side view of a second embodiment of a drinking straw according to the present invention, which includes an integrated device providing an anti-outflow capability.

FIG. 2A illustrates a partial view of FIG. 2, namely a first embodiment of a device providing an anti-outflow capability has been integrated into the drinking straw of FIG. 2.

FIG. 2B illustrates a partial view of FIG. 2, namely a second embodiment of a device providing an anti-outflow capability has been integrated into the drinking straw of FIG. 2.

FIG. 3 illustrates a side view of a third embodiment of a drinking straw according to the present invention, which includes an insertable device providing an anti-outflow capability.

FIG. 3A illustrates a partial view of FIG. 3, namely a further embodiment of the device providing an anti-outflow capability has been inserted into the drinking straw of FIG. 3.

FIG. 3B illustrates a frontal view of the device shown in FIGS. 3 and 3A.

FIG. 3C illustrates a side view of the device shown in FIGS. 3, 3A and 3B.

FIG. 3D depicts a frontal view of an alternative embodiment of the device shown in FIGS. 3 and 3A.

FIG. 3E depicts a side view of the device shown in FIG. 3D.

FIG. 4 illustrates a method of manufacturing a paper drinking straw including the position of a device providing an anti-outflow capability integrated into a paper tape prior to be wound upon a forming mandrel.

FIG. 5 illustrates a portion of a paper tape including the positioning of two devices providing an anti-outflow capability integrated into the paper tape, prior to it being wound to form a paper drinking straw.

FIG. 6 illustrates a method of manufacturing a paper drinking straw including the position of a device providing an anti-outflow capability integrated into a first paper tape prior to be wound upon a forming mandrel, and a second paper tape also used in the production of a paper drinking straw.

FIG. 7 depicts a schematic view of a manufacturing process for a drinking straw, including machine elements utilized in the preparation of a paper tape prior to it being wound upon a forming mandrel, the machine elements including a perforator, and a crimper used in the integration of a device providing anti-outflow capability in the paper tape.

FIG. 8 depicts a further schematic view of a manufacturing process for a paper drinking straw formed using two separate paper tapes (“ribbons”) including machine elements utilized in the preparation of a paper tape prior to it being wound upon a forming mandrel with a second paper tape, the machine elements including a perforator used in the integration of a device providing anti-outflow capability in the paper tape, and an adhesive applicator.

FIG. 8A a schematic view of a different manufacturing process for a paper drinking straw formed using two separate paper tapes (“ribbons”) including machine elements utilized in the preparation of a paper tape prior to it being wound upon a forming mandrel with a second paper tape, the machine elements including a perforator used in the integration of a device providing anti-outflow capability in the paper tape, and an adhesive applicator.

FIG. 8B is a representation of a part of the paper tapes (“ribbons”) at a point in the manufacturing process shown in FIG. 8A.

FIGS. 9A, 9B and 9C depict various embodiments of a paper drinking straw according to an aspect of the invention wherein the straw includes a dose of an ingestible composition.

FIGS. 10, 10A, 10B and 10C depict various further embodiments of a paper drinking straw according to an aspect of the invention wherein the straw includes a dose of an ingestible composition.

FIG. 11 depicts in a schematic view of a still further manufacturing process for a paper drinking straw formed using two separate paper tapes (“ribbons”) including machine elements utilized in the preparation of a paper tape prior to it being wound upon a forming mandrel.

FIG. 11A is a representation of a part of the paper tapes (“ribbons”) at a point in the manufacturing process shown in FIG. 11.

FIG. 12 depicts in a schematic view of a still further manufacturing process for a paper drinking straw formed using two separate paper tapes (“ribbons”) including machine elements utilized in the preparation of a paper tape prior to it being formed into a drinking straw with a vertical seam, and without requiring the use of a mandrel.

FIG. 12A representation of a part of the paper tapes (“ribbons”) at a point in the manufacturing process shown in FIG. 12, in particular the part of the process wherein the paper tapes are wound into a drinking straw with a vertical seam.

FIG. 13 is a further representation of a paper drinking straw according to an aspect of the invention wherein the straw includes a plurality of doses of an ingestible composition within the interior of the straw.

FIG. 14 depicts in a schematic view of a yet further manufacturing process for an anti-outflow device attachment to be added to drinking straws formed using a single paper tape (“ribbon”) including machine elements utilized in the preparation of a paper tape prior to it being formed into a drinking straw attachment using a winding mandrel.

FIGS. 14A-14D illustrate a further representation of sections of the single paper tape (“ribbon”) anti-outflow device attachment during the manufacturing process shown in FIG. 14.

FIGS. 15A, 15B and 15C illustrate further representations of packaged drinking straws of the invention, which include a length of dental floss concurrently provided with the drinking straw.

### DETAILED DESCRIPTION OF THE INVENTION

In the following description, like numerals in the drawing figures are used to indicate a same element which may be found amongst one or more of the separate drawing figures.

The present invention provides improved drinking straws, preferably improved paper drinking straws which do not incorporate a ball and valve seat type of check-valve in their construction, especially the type as illustrated in U.S. Pat. No. D332,198.

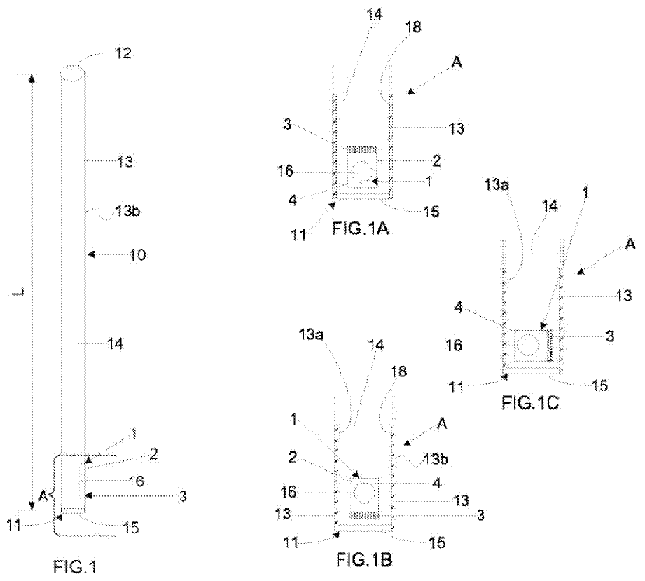

FIG. 1 illustrates a side view of a first embodiment of a drinking straw 10 according to the present invention, which includes an integrated device 1 providing an anti-outflow capability. The drinking straw 10 has two ends, an inlet end 11 and an outlet end 12, between which are extant the straw side wall 13 (having an interior sidewall 13a and an exterior sidewall 13b) which with the two ends 11, 12 define a fluid flow passage 14 (or “interior 14”) between the ends 11, 12. At the inlet end 11 is a plug 15 which defines a liquid-tight barrier against the inflow of any liquid at the inlet end 11. The plug 15 may be formed of a cellulosic material, such as a coated or uncoated paper. The plug 15 may be formed of a non-cellulosic material, such as a polymer which is preferably biodegradable. The plug 15 may be partially cellulosic, and partially non-cellulosic as well. In the near proximity of the plug 15 and extending through a portion of the side wall 13 is an inlet orifice 16 which cooperates with the device providing an anti-outflow capability, here in the form of a flexible flap 2 having a fixed end 3 affixed to an interior surface 18 of the sidewall 13. The fixed end 3 is a part or region of the flap 2 which is movably affixed to the interior surface 18 adjacent or near proximity to the inlet orifice 16, such that the flap 2 is normally biased into a curved or arcuate shape such that it forms a liquid tight seal, or substantially liquid tight seal with the inlet orifice 16, wherein dimensions of the flap 2 at the unfixed end 4 are sufficiently large such that a part or face of the unfixed end 4 covers and blocks fluid flow through the orifice 16. Thereby, any liquid within the fluid flow passage 14 is retained within that passage when the straw 1 is in a vertical orientation, and the outlet and 12 is open to the ambient atmosphere, i.e. a reduced pressure condition does not exist within the fluid flow passage 14. Such a reduced pressure condition arises when a user surrounds the outlet and 12 with their lips, and generates a vacuum in their buccal cavity, which decreases the relative pressure within the fluid flow passage 14 relative to the ambient environment. When such a condition arises,—as would be typical when a user uses the drinking straw for its avowed purpose, namely drawing a liquid from the inlet end, through the fluid flow passage 14, and out from the outlet and 12—, the unfixed end 14 of the flap 2 deforms from its prior condition and contact between the flap 2 and the inlet orifice 16 is reduced or removed, thereby allowing for the influx of a liquid surrounding the inlet end 11 to enter into the fluid passage 14, and under the influence of continued reduced pressure (“suction”) the fluid is drawn up and outwardly from the outlet end 12 and into the buccal cavity. However, the converse occurs when the reduced pressure is terminated and the pressure at the outlet end 12 is returned to normal atmospheric pressure; under such a condition the flexible flap 2 returns to his prior, unbiased condition and the unfixed end 4 again abuts the interior surface 18 of the sidewall 13 and thereby provides a liquid tight, or substantially liquid tight seal of the inlet orifice 16. In such a condition, any remaining liquid within the fluid passage 14 remains and little or no liquid flows flow out from the inlet end 11 or the inlet orifice 16. The ability of the drinking straw 11 of FIG. 1 to retain such liquid depends upon the sealing ability of the flexible flap 2 and in particular its unfixed end 4 to form a liquid tight interface over the inlet orifice 16; a choice of materials which provides a good liquid tight seal may retain liquid within the fluid passage 14 indefinitely. As to a preferred placement of the inlet orifice 16, as illustrated on FIG. 1, the drinking straw 10 has an overall length “L” as measured between its inlet end 11 and outlet end 12, and is preferred that the inlet orifice be not more than 33% of the length “L”, more preferably not more than 25%, still more preferably not more than 15%, especially preferably not more than 10% of the length “L” as measured from the inlet end 11. In this manner, the approximate placement of the inlet orifice 16 permits for the substantial evacuation of the container containing a liquid.

FIG. 1A depicts a more detailed view of a first embodiment of a device 1 providing an anti-outflow capability integrated into the drinking straw of FIG. 1; here in the form of a flap 2 having a fixed end 3 and a free end 4. As shown, the plug 15 fits transversely across the sidewall 13. The fixed end 3 is affixed to an interior surface 18 of the sidewall 13 by suitable means, which can be one or more of: a region of an applied adhesive, a mechanical press-fit or crimping, or a heat seal. FIG. 1A also illustrates the inlet orifice 16 as being a substantially circular and extending through the sidewall 13 as well as its relative location and position proximate to the inlet end 11. FIG. 1A illustrates that the fixed end 3 in this embodiment is positioned ‘above’ the inlet orifice 16 at a region distal from the inlet end 11 and the plug 15.

FIG. 1B which also depicts a partial view of FIG. 1, in the region marked “A” between, and is for the most part substantially similar to what is illustrated in FIG. 1A, but differs in that in this figure, a second embodiment of a device 1 providing an anti-outflow capability integrated into the drinking straw of FIG. 1 is illustrated. The device 1 is also in the form of a flexible flap 2 having a fixed end 3 and a movable, free end 4. Similarly, FIG. 1B also illustrates the inlet orifice 16 as being a substantially circular and extending through the sidewall 13 as well as its relative location and position proximate to the inlet end 11. FIG. 1B differs in that it illustrates that the fixed end 3 in this embodiment is positioned ‘below the inlet orifice 16 at a region proximate from the inlet end 11 and the plug 15, viz., between the plug 15 and the inlet orifice 16 and is transverse to the sidewall 13.

FIG. 1C illustrates a partial view of FIG. 1, namely a third embodiment of a device 1 providing an anti-outflow capability has been integrated into the drinking straw of FIG. 1, and is also similar in many respects with prior FIG. 1A and FIG. 1B. Here to, the device 1 is also in the form of a flexible flap 2 having a fixed end 3 and a movable, free end 4. Similarly, FIG. 1C also illustrates the inlet orifice 16 as being a substantially circular and extending through the sidewall 13 as well as its relative location and position proximate to the inlet end 11. FIG. 1C differs in that it illustrates that the fixed end 3 in this embodiment is positioned in parallel to the length of the sidewall 13 and substantially perpendicular to the plug 15 and the inlet end 11.

It is to be here noted that the plug 15 illustrated on FIGS. 1, 1A, 1B, and 1C is illustrated as extending substantially only within the interior of the inlet end 11 and thereby providing a liquid tight seal, it is to be understood that the configuration of this plug 15 may differ. For example, it is also within the scope of the invention wherein the configuration of the plug 15 is more in the form of a cap and extends about the exterior of the sidewall 13 and thereby encases the inlet end 11. Other configurations may also be used with similar beneficial effects.

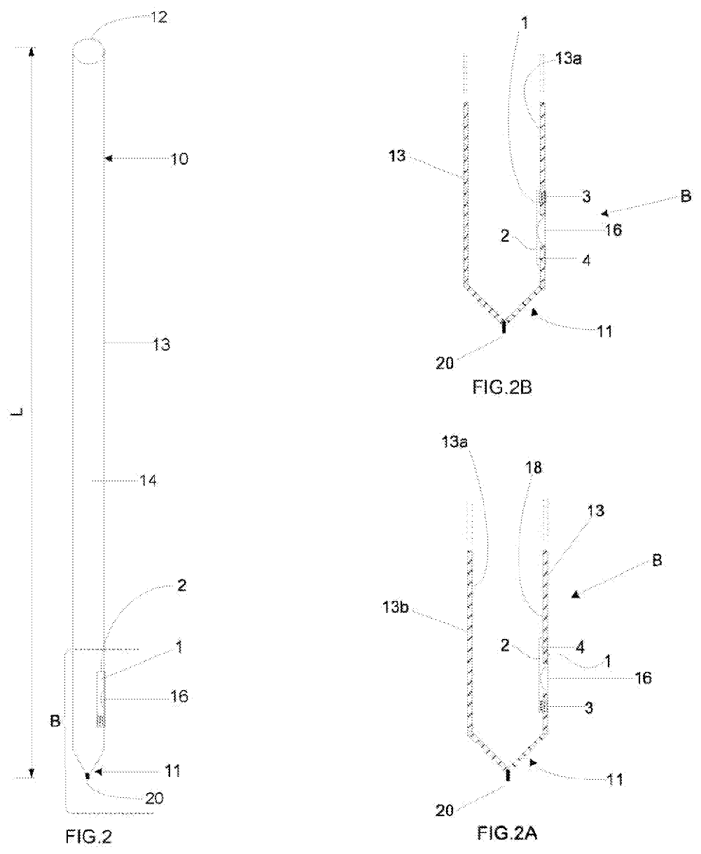

FIG. 2 illustrates a side view of a second embodiment of a drinking straw 10 according to the present invention, which includes an integrated device 1 providing an anti-outflow capability. The embodiment of FIG. 2 is very similar in most regards with the embodiment previously illustrated in FIG. 1, and only differs in that the plug 15 of FIG. 1 is omitted, and is replaced by a pinch or crimp 20 closing to the inlet end 11. This obviates the need for a plug 15 as the crimp 20 also provides a fluid-tight seal to an end of the drinking straw 10. The embodiment of FIG. 2 includes the integrated device 1 which is substantially similar to anyone of the embodiments previous disclosed with respect to any one of FIGS. 1, 1A, 1B or 1C.

A more detailed view of the integrated device 1 providing an anti-outflow capability of FIG. 2 is illustrated on FIG. 2A which provides a detail of the region “B” indicated on FIG. 2. As can be seen thereon, the device 1 is also in the form of a flap having a fixed end 3 affixed to a part of the interior sidewall 13a and a free end 4 which is moveable away from the interior sidewall 13a, but when no reduced pressure condition exists, the flap 2 is biased due to its arcuate curvature lays in register against a part of the inner sidewall 13a and forms a seal with the inlet orifice 16. A similar effect is realized in other embodiments of the present invention disclosed herein. As shown, the crimp 20 seals the inlet end 11. The fixed end 3 is affixed to an interior surface 18 of the sidewall 13 by suitable means, which can be one or more of: a region of an applied adhesive, a mechanical press-fit or crimping, or a heat seal. FIG. 2A also illustrates the inlet orifice 16 as being a substantially circular and extending through the sidewall 13 as well as its relative location and position proximate to the crimp 20 at the inlet end 11. FIG. 2A further illustrates that the fixed end 3 in this embodiment is positioned ‘above’ the inlet orifice 16 at a region distal from the inlet end 11 and the crimp 20.

FIG. 2B which also depicts a partial view of FIG. 2, in the region marked “B” between, and is for many respects substantially similar to what is illustrated in FIG. 2A, but differs in that in this figure, a further embodiment of a device 1 providing an anti-outflow capability integrated into the drinking straw of FIG. 2 is illustrated. The device 1 is also in the form of a flexible flap 2 having a fixed end 3 and a movable, free end 4. Similarly, FIG. 2B also illustrates the inlet orifice 16 as being a substantially circular and extending through the sidewall 13 as well as its relative location and position proximate to the sealed inlet end 11 and the crimp 20. FIG. 2B differs in that it illustrates that the fixed end 3 in this embodiment is positioned below the inlet orifice 16 at a region proximate from the inlet end 11 and the crimp 20, viz., between the crimp 20 and the inlet orifice 16 and is transverse to the sidewall 13.

In the drawing of FIGS. 2, 2A and 2B it is understood that the crimp 20 is formed by pressing together the generally circular inlet end to flatten it, and thereafter a crimp 20 is formed, which is generally linear. However crimps 20 can be formed having other profiles, i.e, conical, frustoconical or hemispherical in shape. By way of non-limiting example such may be achieved by compressing the inlet end 11 into sealed form in such a non-linear crimp shape, optionally utilizing an adhesive. Such compression may be facilitated by first providing indentations, cuts or recess in the inlet end 11 prior to being formed into a crimp 20.

While not illustrated in any of the drawings relating to FIG. 2, it is to be understood that the device 1 may be affixed to the sidewall 13 of the drinking straw 10 such that its fixed end 3 is positioned in parallel to the length of the sidewall 13 and substantially perpendicular to the crimp 20 at the inlet end 11.

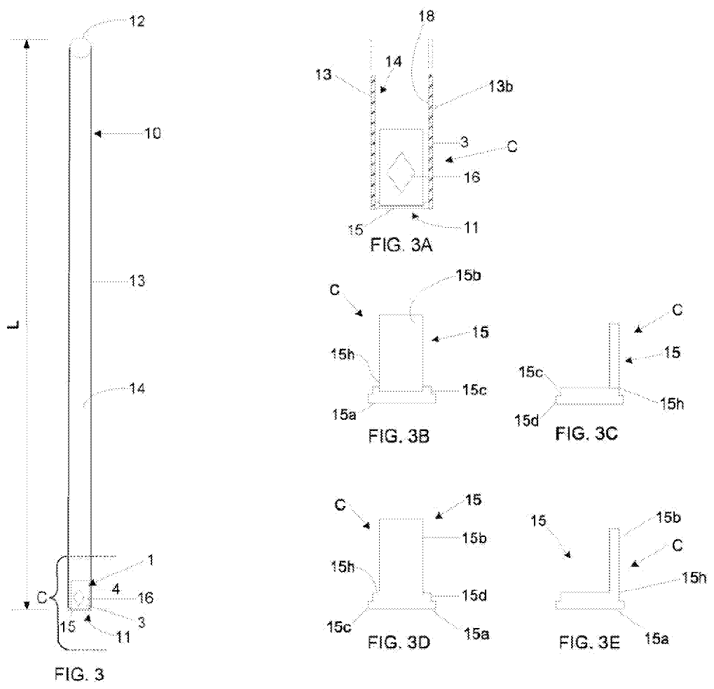

FIG. 3 depicts a further embodiment of a drinking straw 10 which depicts the same features as the drinking straws illustrated with regard to the former figures discussed herein. The embodiment of the drinking straw 10 in FIG. 3 differs from the former figures in that the integrated device 1 providing an anti-outflow capability is in the form of an insertable plug 15 having a base part 15a from which depends a movable, hinged flap part 15b which is affixed at a hinge section 15h; in use the hinged flap part 15b may move towards an inlet orifice 16 and when abutting it, form a substantially, totally liquid tight seal there with, or, may move away from the inlet orifice 16 such as when under the influence of a reduced pressure condition within the drinking straw 10 to thereby permit for the entry of a liquid into fluid flow passage 14. The operation of this hinged flap part 15b is in most respects similar to that of the free end 4 described with reference to prior drawing figures whereas the operation of the hinge section 15h is in most respects similar to that of the fixed end 3 described with reference the prior drawing figures.

FIGS. 3 and 3A also illustrates an alternative embodiment for a geometric configuration of the inlet orifice 16, namely in the shape of a “diamond” as opposed to the substantially circular configuration of the inlet orifice 16 disclosed in prior drawing figures. It is to be understood thereby that the configuration of the inlet orifice is not constrained to any particular geometric or irregular shape but it is only required that such an orifice exist whereby liquid surrounding the inlet end 11 of the drinking straw 10 may pass into the interior of the drinking straw under a reduced pressure condition within its fluid flow passage 14. While not illustrated, it is to be understood also that more than one, that is to see a plurality of inlet orifices 16 which may be of the same, or different configurations or shapes (not limited to geometric, or irregular shapes) may also be used.

As is seen in FIGS. 3B and 3C, which respectively illustrate a front view, and a side view of the integrated device 1 shown on FIGS. 3 and 3A, the insertable plug 15 has a base part 15a from which depends a movable, hinged flap part 15b which is affixed at a hinge section 15h, Further the base part 15a optionally, but preferably further includes a circumferential recess 15c at the peripheral wall 15d; an extant circumferential recess 15c may be sized to permit for the insertion of the base part 15a transversely and into the inlet end 11 of the drinking straw 10 wherein the narrowed portion fits between the sidewall 13 thereof, and provide a substantially or totally fluid tight seal therewith. It is to be further understood with reference to FIGS. 3B and 3C that the embodiment illustrated that there of the device 1 may be formed from two discrete parts, each part of which may also be of a different material of construction, which two discrete parts are only joined at the hinge section 15h.

FIGS. 3D and 3E respectively illustrate a front view, and a side view of a further embodiment of an integrated device 1 as shown on FIGS. 3 and 3A, the insertable plug 15 having a base part 15a from which depends a movable, hinged flap part 15b which is affixed at a hinge section 15h, but in which the base part 15a and hinged flap part 15b are integrally formed, and or are formed from the same material of construction. The illustrated embodiment of FIGS. 3D and 3E function in a manner that can be described with reference to FIGS. 3, 3A, 3B and/or 3C.

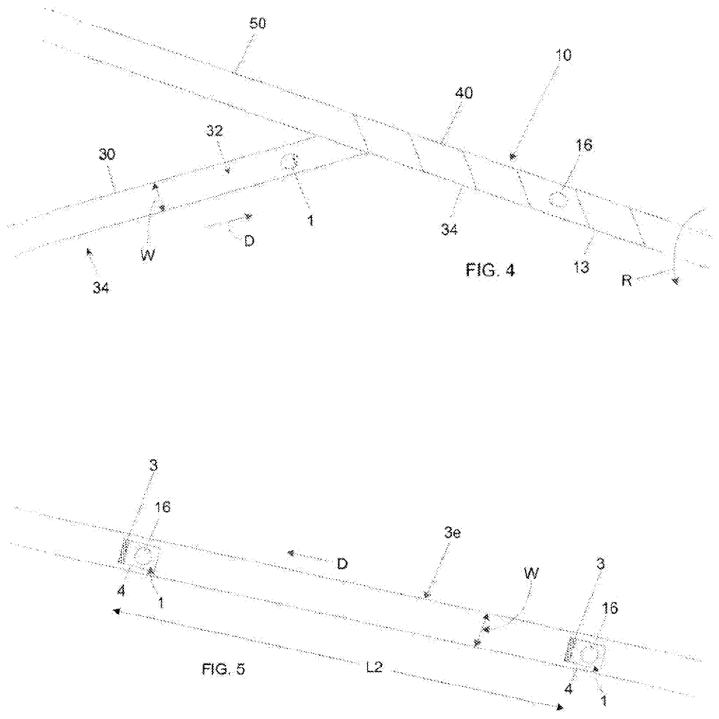

FIG. 4 illustrates a method of manufacturing a paper drinking straw 10 from a paper tape 30 including the positioning of a device 1 providing an anti-outflow capability integrated into a paper tape 30 prior to being wound upon a forming mandrel 50. As can be seen from the figure, a rotating forming mandrel 50, here rotating in a counterclockwise direction as indicated by the arrow “R” (a clockwise direction is also clearly possible upon suitable placement of the paper tape 30) is used to form a continuous tube shaped spiral from a paper tape 30 supplied to the mandrel 50. In preferred embodiments the paper tape 30 has a thickness between 0.01 mm-3 mm, more preferably between 0.05 mm-2 mm. The paper tape 30 is substantially flat, has a transverse width (indicated by “w”) is dimension is at least five times, preferably at least 10 times the thickness of the paper tape 30. The paper tape 30 also has a length which is preferably at least 10 times the transverse width. The paper tape 30 has both a top face 32 and an opposite bottom face 34; in the illustrated embodiment, the top face 32 comes into interfacial contact with the surface of the winding mandrel 50 as it rotates, and the direction “D” of the supply of the paper tape and its angle relative to the winding mandrel 50 is controlled in such a manner that a continuous spiral of the paper tape 30 is formed, such that a part of the top face 32 a part of the bottom face 34 such that a fluid flow passage can be defined. Preferably, an adhesive is positioned at these overlapped regions which solidifies or otherwise hardens relatively rapidly, such that discrete segments of the continuous tube-shaped spiral can be segmented to form individual drinking straws 10. As can be seen from FIG. 4, parts of the paper tape 30 having perforations 16 over which are positioned a device 1 providing an anti-outflow capability, which once affixed to the paper tape 30, are considered to be integrated into a paper tape 30. As discussed with reference to FIGS. 1, 1A, 1B, 1C, 2, 2A, 2B the fixed end 3 is affixed to a part of the paper tape 30 adjacent to an orifice 13 prior to winding the paper tape onto a forming mandrel 50.

The illustrated embodiment of FIG. 4 depicts a method of constructing a drinking straw in accordance with the embodiment illustrated on any of the prior drawing figures FIGS. 1, 1A, 1B, 1C, 2, 2A, 2B. In the embodiment relevant to FIGS. 1, 1A, 1B, 1C and subsequent to winding of the paper tape 30 and separation into discrete segments or lengths, a plug 15 can be added to the inlet end 11 of a drinking straw 10 in order to complete its manufacture. In the embodiment relevant to FIGS. 2, 2A, 2B and subsequent to winding of the paper tape and separation into discrete segments or lengths, a crimp 20 can be formed at the inlet end 11 of a drinking straw 10 in order to complete its manufacture. Where a drinking straw 10 according to the embodiment depicted on FIGS. 3, 3A, 3B, 3C, 3D, or 3E, it is to be understood that in most regards such an alternative method is similar to that described with reference to FIG. 4, except that instead of the affixation of the device 1 providing an anti-outflow capability to the paper tape 30 before it is wound onto the mandrel 50, such an affixation step can be omitted and instead, following the production of a drinking straw 10, subsequently a device 1 as depicted on FIGS. 3, 3A, 3B, 3C, 3D, or 3E can be inserted into the inlet 11 of a drinking straw 10 to thus complete its manufacture.

Turning now to FIG. 5, therein is illustrated a portion of a paper tape 30 as is also illustrated in FIG. 4. The depiction of FIG. 5 illustrates that prior to winding upon the winding mandrel 50, the paper tape 30 is provided with regularly spaced apart perforations 16, which in the embodiment adjacent perforations 16 are spaced apart a length “L2”, and covering the perforations 16 are the free ends 4 of the flaps of the device 1, and the fixed ends 3 affixed to the paper tape 30. Optionally, but preferably the spacing between spaced apart perforations 16 is consistent along the length of the paper tape 30 as it provides for predictable placement of the orifices 16 during the spiral winding operation such that preferably, the orifices 16 are all collinear or otherwise in a consistent location relative to the winding mandrel.

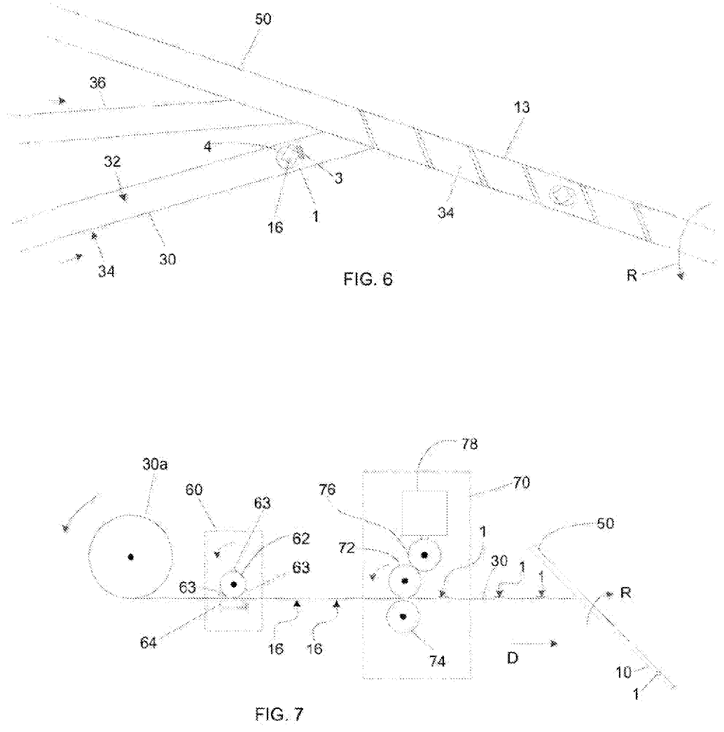

FIG. 6 illustrates a further method of manufacturing a paper drinking straw 10 according to an embodiment of the present invention, which drinking straw 10 is formed from two separate paper tapes, a first paper tape 30 which includes an integrated device 1 providing an anti-outflow capability integrated into a first paper tape 30 prior to be wound upon a forming mandrel 50, and a second paper tape 36 also used in the production of a paper drinking straw 10. The method depicted on FIG. 6 is in the most regards similar to that depicted and discussed relative to FIG. 4, and the first paper tape 30 is the same as that used in the method of FIG. 5 and illustrated and discussed with reference to FIG. 5. The method according to FIG. 6 differs in that an additional second paper tape 36 is concurrently wound upon the forming mandrel 50 rotating in the direction “R” with the first paper tape 30 such that overlapping of the first paper tape 30 with the second paper tape 36 is caused to occur. Such may be advantageous for a variety of reasons including but not limited to: the provision of the second paper tape 36 provides an additional interlaminar layer which stiffens the sidewall of the drinking straw 10 ultimately formed, the provision of the second paper tape 36, particularly were such is of a different color than that of the first paper tape may provide a more commercially appealing appearance to potential customers who would see a very visible spiral defined by the sidewall 13 of the drinking straw 10 ultimately formed.

It is to be understood that the method according to the present invention, and discussed with reference to FIGS. 4, 5 and 6 may include further additional steps which facilitate the manufacture of a drinking straw 10 according to the present invention. Here, reference is made to the schematic drawing provided in FIG. 7 which provides a schematic view of a first manufacturing process for a drinking straw 10, which in addition to the winding mandrel 50 rotating in the clockwise direction “R” (but which may be counterclockwise, as discussed with prior drawing figures) upon which is formed a spiral of the paper tape 30 are depicted further, “upstream” elements. As is seen on FIG. 7, the paper tape 30, supplied from a bulk roll 30a which preferably, it has previously been suitably dimensioned to the appropriate width “w”, but is not perforated by any of the inlet orifices 16. The paper tape 30 is supplied and unrolled in the direction “D” where it is next acted upon by a punch press unit 60, identified as the machine elements within that the box depicted in “broken lines”. The punch press unit 60 operates to perforate the tape 30 at desired locations, preferably at regularly spaced distances between adjacent inlet orifices 16 as discussed with reference to FIG. 5, such provides a plurality of inlet orifices along the length of the paper tape 30. In the depicted embodiment of FIG. 7, the punch press unit 30 includes a punch roller 62 which rotates and includes a plurality of equally spaced apart punch heads 63 which one coming into contact with the paper tape are pressed against an opposing anvil 64 and thereby cause the formation of an inlet orifices 16 passing through the body of the paper tape 30. (But it is of course to be understood that a different configuration, or different apparatus can be used in the place of the punch press unit 60 depicted herein, i.e., a linear stamping press, a reciprocating punch press, and the like.) The perforated paper tape 30 next continues to move in the direction “D” to bonding unit 70 which operates to apply a device 1 in the locus of the inlet orifices 16. As noted, the bonding can be by any means wherein a part of the device 1 is affixed to a surface of the paper tape 30 prior to winding. Such include, but are not limited to: a region of an applied adhesive, a mechanical press-fit. crimping, stamping, a heat seal, ultrasonic welding, or other means which would not compromise the fluid tight integrity of the paper tape 30 which is ultimately formed into the sidewall 13 of a drinking straw 10. In the depicted embodiment of the bonding unit 70, identified as the collection machine elements within the box depicted in broken lines, feed hopper 78 supplies devices 1 to a supply roller 76 which rotates and during this rotation supplies individual devices 1 to one of the counter-rotating pinch rollers 72, 74. During this rotation, device 1 is applied by pinch roller 72 to the paper tape 30 in the locus of an extant perforation 16, and is bonded thereto in order to “integrate” it with the paper tape 30 (alternately paper ribbon 30). The paper tape 30 of a single ribbon now integrated with devices 1 providing an anti-outflow capability continues to travel in the direction of arrow “D” wherein it is wound spirally onto a rotating forming mandrel 50 to form a continuous tube, which when cut in segments (this operation is not shown) forms paper drinking straws 10 which may be post processed in order to form a final embodiment of a paper drinking straw 10, as discussed previously.

The foregoing apparatus of FIG. 7 may also be used in forming a paper drinking straw 10 consistent with the embodiment of FIGS. 1, 1A, 1B, 1C, a plug 15 is added onto, over or within the inlet end 11 of a drinking straw 10 in order to complete its manufacture. In the embodiment relevant to FIGS. 2, 2A, 2B a crimp 20 is formed at the inlet end 11 of the drinking straw 10 to complete its manufacture.

Where a drinking straw 10 according to the embodiment depicted on FIGS. 3, 3A, 3B, 3C, 3D, or 3E, it is to be understood that the use of a bonding unit 70 shown on FIG. 7 is omitted, as such an affixation step can be omitted and instead, following the production of a drinking straw 10, subsequently a device 1 as depicted on FIGS. 3, 3A, 3B, 3C, 3D, or 3E can be inserted into the inlet 11 of a drinking straw 10 to thus complete its manufacture.

The apparatus of FIG. 7 may also be used in forming a paper drinking straw 10 according to the invention using two (or more) separate paper tapes, i.e., such as paper tape 30 and at least one further paper tape, i.e., such as paper tape 36 as discussed with reference to FIG. 6, it being only required that any further paper tape be supplied from a suitable supply source and suitable supply means to the rotating mandrel 50.

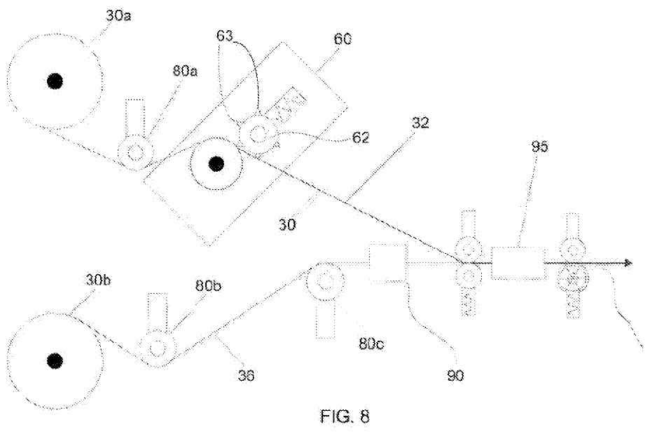

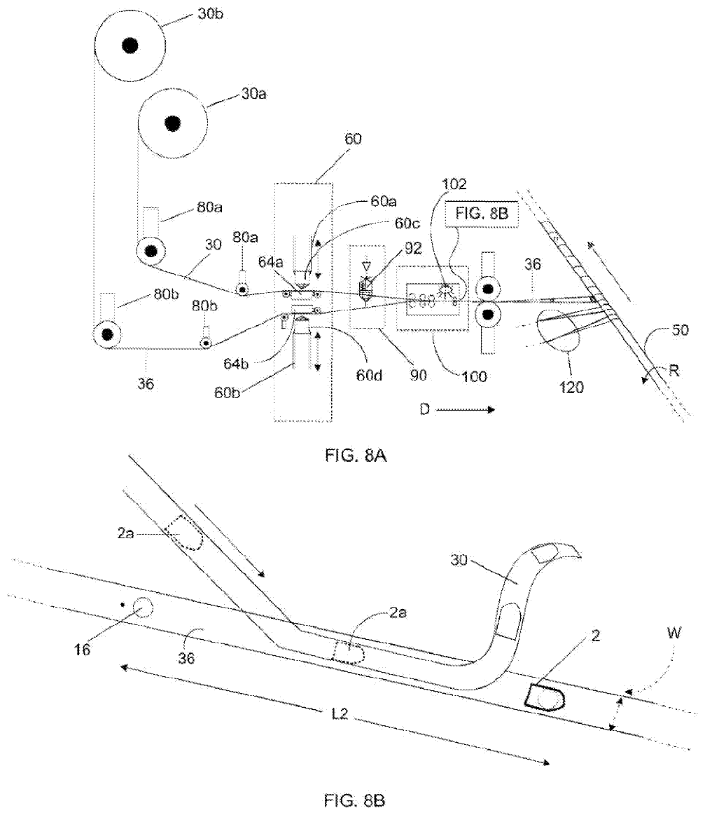

FIG. 8 depicts a further schematic view of a manufacturing process for a paper drinking straw 10 according to certain aspects of the present invention; the manufacturing process is related to the foregoing FIG. 6 and the discussion above. In the depicted manufacturing process, a first paper tape 30 is supplied from a first bulk roll 30a, and a second paper tape 36 is supplied from a second bulk roll 30b. The first paper tape 30 passes by a supply/tensioning roller 80a to a punch press unit 60 operates to perforate at desired locations, preferably at regularly spaced distances between adjacent inlet orifices 16 (as discussed with reference to FIG. 5), a plurality of inlet orifices along the length of the paper tape 30; in this embodiment the punch press unit 60 also operates as a bonding unit 70 which operates to apply in the locus of the inlet orifices (not visible in this drawing figure). Concurrently the second paper tape 36 is unrolled from the second bulk roll 30b past a supply/tensioning roller 80a and a second supply/tensioning roller 80C to an adhesive unit 90 which applies a UV curable (but other adhesive may be used as well, preferably a biodegradable adhesive composition) adhesive which is applied to parts of paper tape 36. Thereafter, the two tapes 30, 36 are bonded together in register (or laminated, or layered) and supplied to adhesive curing unit, i.e. a high intensity UV source nor to rapidly cure the UV curable adhesive. Thereafter the bonded tapes 30, 36 are passed to a winding mandrel 60 and formed into a continuous tube which is subsequently cut into segments, as described with reference to FIG. 4 and/or FIG. 6.

FIG. 8A a schematic view of a different manufacturing process for a paper drinking straw according to certain aspects of the invention formed using two separate paper tapes 30, 36 (“ribbons”) including machine elements for providing a separable flap 2 part from the first paper tape 30 and an orifice 16 in the second paper tape 36. The process of FIG. 8A and differs in that the in the process the first paper tape 30 passes from a first bulk roll 30a pass tensioning rollers 80a where the paper tape is provided with flap-shaped perforated parts 2a which when separated from the first paper tape 30 provide flexible flaps 2a which are fixable to parts of the second paper tape 36, being supplied from a second supply roll 30b. In this manufacturing process, the punch press unit 60 provides a dual function, namely and that includes a first punch, here a reciprocating punch 60a having a die 60c which is in the form of a flap 2a such that when the die 60c is urged against its anvil 64A it produces the separable flap 2a which is seen in better detail on FIG. 8B. Such separable flaps 2a are formed at desired distances, usually a length L2 along the length of the first paper tape 30. Concurrently the punch press unit 60 also includes a second punch, here a reciprocating punch 60b which has a die 60d which is in the form of an orifice 16 such that when its die 60d is urged against its anvil 64b, it produces the perforation which is the orifice 16 in the second paper tape 36. Such orifices 16 are formed at desired distances usually a length L2 of the second paper tape 36. As is more readily understood with regard to FIG. 8b, the linear speed and direction of travel, represented by the arrow labeled “D” in FIG. 8A ensures that during the process, the separable flaps 2a are overlaid the perforation 16, such that when the first paper tape 30 is withdrawn, the flexible flaps 2 are maintained such that a major portion thereof obscures a corresponding orifice 16. Again, as with the prior representations, is to be understood that while a reciprocating punch type press used in the current manufacturing process, other machines and methods for forming perforated flaps 2a and orifices 16 in the respective paper tapes 30, 36, i.e., a rotary press, a linear stamping press, and the like may be used as well. Subsequent to the operations of the punch press unit 60 it is to be understood that the separable flaps 2a are still part of the first paper tape 30, but the orifices 16 have been formed in the second paper tape 36 and define passages through the paper tape 36. In the adhesive supply unit illustrated by the dotted box 90 is provided an adhesive supply unit 92 which supplies a small amount of a suitable adhesive, such as a thermally curable, or chemically curable adhesive. Such can be a UV curable adhesive material, or may be any other material which can because to rapidly cure, harden or viscosify under the influence of a suitable electromagnetic source, such as UV, microwaves, heat, or other source of electromagnetic energy. Alternately, in certain embodiments such adhesive supply unit 90 is omitted wherein in a subsequent step in mechanical bonding, such as a pressure fit or crimping can be used to at least temporarily affix a separated flap 2a such that a least a part of it obscures an orifice 16. In the depicted process of FIG. 8A, a laminator unit illustrated by the dotted box 100 is present downstream; in this laminator unit 10 the first paper tape 30 having the separable flaps 2a are laminated together with the second paper tape 30 and the adhesive material is cured utilizing a suitable source of electromagnetic energy 102, i.e., a UV source and downstream of which, subsequent to curing, the first paper tape 30 is withdrawn, but the flaps 2 which are now bonded to the second paper tape 36 continue further downstream to the winding mandrel 50 where the paper tape 36 is spirally wound to form drinking straws 10. In the depiction of FIG. 8A is shown the optional use of a third and a fourth paper tape, (collectively indicated as 120) which may be supplied by suitable means, not shown and fed to the rotating forming mandrel 50 concurrently with the paper tape 36; in this way and in accordance with an optional process, a drinking straw 10 according to invention formed of two or more discrete paper tapes can be produced.

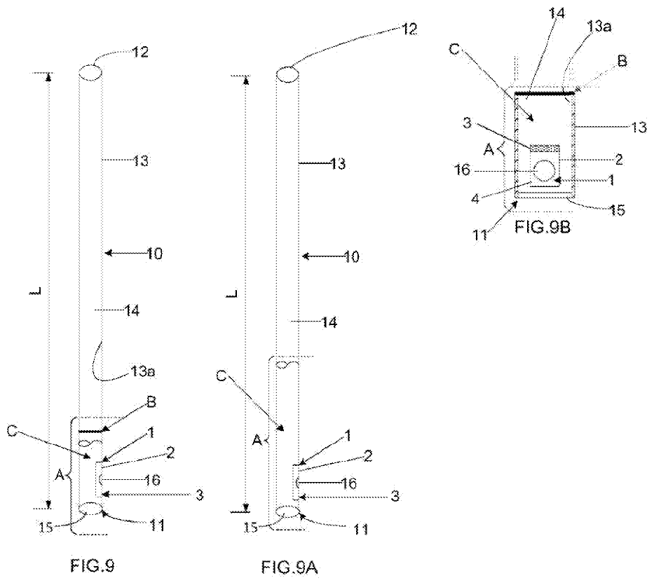

FIGS. 9A, 9B and 9C depict various embodiments of a paper drinking straw 10 according to an aspect of the invention wherein the straw includes a least one mass, quantity, or dose of an ingestible composition C. In each of the embodiments, a portion “A” of the drinking straw 10 includes within its interior fluid flow passage 14 a quantity of an ingestible composition “C”. Such ingestible composition C may be retained within only a portion of the interior 14 (or “fluid flow passage 14”) of the drinking straw 10 by either being applied to only the interior side wall 13a, or take up a portion of the volume in the region A wherein it is retained within this region by a breachable element B which can be a frangible material such as starch, sugar, or other materials which forms a physical barrier or a plug which transverses and extends across the inner diameter of the drinking straw 10, with the ingest composition being retained between the end of the drinking straw 10 and the breachable element B; the detail of such an embodiment is illustrated in FIGS. 9 and 9B, the latter being a more detailed view of the former. In an alternative, wherein the ingestible composition C may be formed into a non-flowable mass, as opposed to a liquid or particulate (i.e, a powder) which, upon inversion of the straw 10 would readily flow out from the straw in an undesirable fashion, use of a breachable element B is not necessary; such an embodiment is illustrated in FIG. 9A.

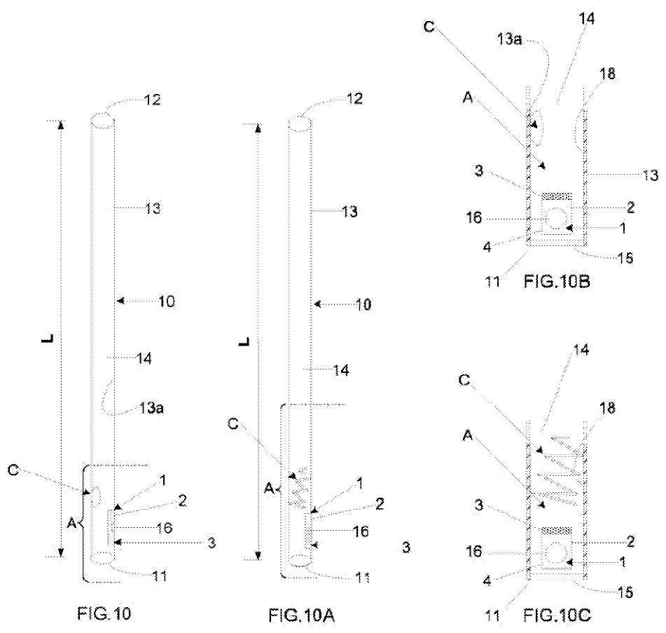

FIGS. 10, 10A, 10B and 10C depict various further embodiments of a paper drinking straw 10 according to an aspect of the invention wherein the interiors 14 also include at least one mass, quantity or dose of an ingestible composition C, of various physical forms which may also be included within the interior 14 of drinking straws according to the present invention. In these depict embodiments, the just composition may take the form of a pre-formed body of a ingestible composition, such as a droplet, pastille, pill, tablet, or a three-dimensional body such as the form of a spiral-shaped mass of an ingestible composition C, the forms of pastilles adhere to the inner side wall 13a are shown in both FIGS. 10, 10B and are seen to be proximate to the integrated device 1 providing an anti-outflow capability, viz, in the region “A”, whereas in FIGS. 10A and 10C are seen embodiments of a spiral-shaped mass of an ingestible composition C proximate to the integrated device 1 an anti-outflow capability.

The ingestible composition C may be any ingestible material which can provide a nutritious, flavoring, medical, therapeutic, or virtually any other organoleptic perception or benefit to a person utilizing the straw 10 of the present invention. Nonlimiting examples include those pharmaceutical preparations, nutraceutical preparations, confectionery compositions, both natural and/or an artificial sweeteners, flavoring compositions, which, when ingested with a liquid being supplied via the orifice, may be drawn up by a person utilizing the straw who can then enjoy the dilution, dispersion, or suspension formed.

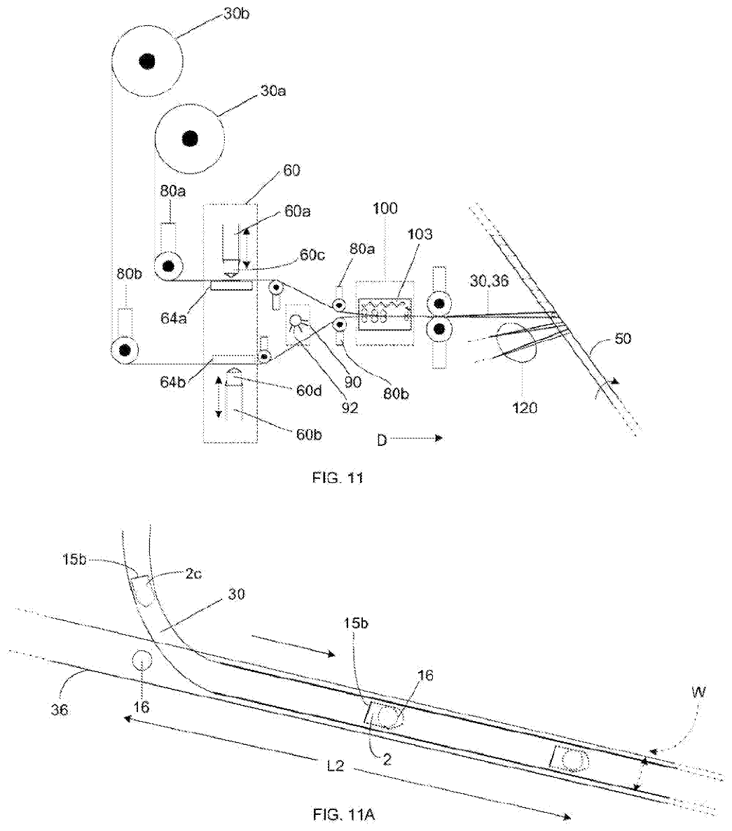

FIGS. 11 and 11A provide schematic views of a further, different manufacturing process for a paper drinking straw according to certain aspects of the invention formed using two separate paper tapes 30, 36 (“ribbons”) including machine elements for providing a non-separable flap 2c part from the first paper tape 30 and an orifice 16 in the second paper tape 36. The process of FIGS. 11, 11A is similar in many respects to that discussed with reference to the process disclosed in FIGS. 8, 8A, albeit with the difference that the flap 2 formed in the first paper tape 30 is not fully separated from the first paper tape 30 and that both the first paper tape 30 and the second paper tape 36 having the orifices 16 are laminated, and wound spirally upon the rotating forming mandrel 50. In the current manufacturing process depicted, the first paper tape 30 passes from a first bulk roll 30a past tensioning rollers 80a where the paper tape is provided with flap-shaped perforated parts 2c having a an integral, hinged flap part 15b is not separated from the paper tape 30; the perforated parts 2c are ultimately separated from the paper tape 30, but by virtue of the flap part 15b the flap 2 remains hingedly affixed and depending from the paper tape 30. As in the process described with referenced to FIGS. 8, 8A, the second paper tape 36 is provided with orifices 16 at desired lengths, i.e. L2 along the length of the second paper tape 36. These formation of the integral, hinged flap part 15b and the orifices 16 are provided by a punch press unit 60 provides a dual functions, namely and that includes a first punch, here a reciprocating punch 60a having a die 60c which is in the form of the integral, hinged flap part 15b such that when the die 60c is urged against its anvil 64A it produces the perforated parts 2c of the flap 2 which is seen in better detail on FIG. 11B. Such hingedly affixed flaps 2 are also formed at desired distances, usually a length L2 along the length of the first paper tape 30. Concurrently the punch press unit 60 also includes a second punch, here a reciprocating punch 60b which has a die 60d which is in the form of an orifice 16 such that when its die 60d is urged against its anvil 64b, it produces the perforation which is the orifice 16 in the second paper tape 36. Such orifices 16 are formed at desired distances usually a length L2 of the second paper tape 36. As is more readily understood with regard to FIG. 11a, the linear speed and direction of travel, represented by the arrow labeled “D” in FIG. 11A ensures that during the process, the separable flaps 2a are overlaid the perforation 16, such that when the first paper tape 30 is withdrawn, the flexible flaps 2 are maintained such that a major portion thereof obscures a corresponding orifice 16. Again, as with the prior representations, is to be understood that while a reciprocating punch type presses used in the current manufacturing process, other machines and methods for forming flaps 2 and orifices 16 in the respective paper tapes 30, 36, i.e., a rotary press, a linear stamping press, and the like may be used as well. Subsequent to the operations of the punch press unit 60 it is to be understood that the flaps are still part and depend from adjacent parts of the first paper tape 30, but the orifices 16 have been formed in the second paper tape 36 and define passages through the paper tape 36. In the adhesive supply unit illustrated by the dotted box 90 is provided an adhesive supply unit 92 which supplies a small amount of a suitable adhesive onto parts of the surface of the second tape 36, such an adhesive may be a thermally curable, or chemically curable adhesive. Such can be a UV curable adhesive material, or may be any other material which can because to rapidly cure, harden or viscosify under the influence of a suitable electromagnetic source, such as UV, microwaves, heat, or other source of electromagnetic energy. (Alternately, in certain embodiments such adhesive supply unit 90 is omitted wherein in a subsequent step in mechanical bonding, such as a pressure fit or crimping can be used to at least temporarily affix a flap 2 such that a least a part of it obscures an orifice 16.) In the depicted process of FIG. 11, a laminator unit illustrated by the dotted box 100 is present downstream; in this laminator unit 100 aligns and laminates the first paper tape 30 having the depending flaps 2 with the second paper tape 30 and the adhesive material is cured utilizing a suitable source of electromagnetic energy 103, i.e., a heat source and downstream of which, subsequent to curing of the adhesive, the laminated first paper tape 30 comprising the integral flaps 2 layered upon the second paper tape 36 comprising certainly positioned orifices 16 continue to travel downstream to the winding mandrel 50 where the paper tapes 30, 36 is spirally wound to form drinking straws 10. In the depiction of FIG. 11 is shown the optional use of a third and a fourth paper tape, (collectively indicated as 120) which may be supplied by suitable means, not shown and fed to the rotating forming mandrel 50 concurrently with the laminated paper tape 30,36; in this way and in accordance with an optional process, a drinking straw 10 according to invention formed of three or more discrete paper tapes can be produced.

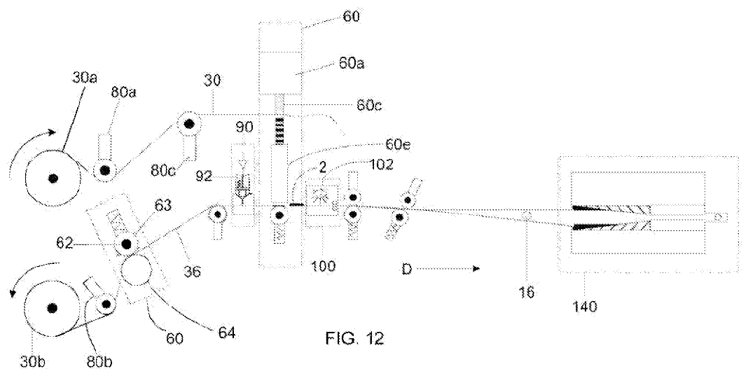

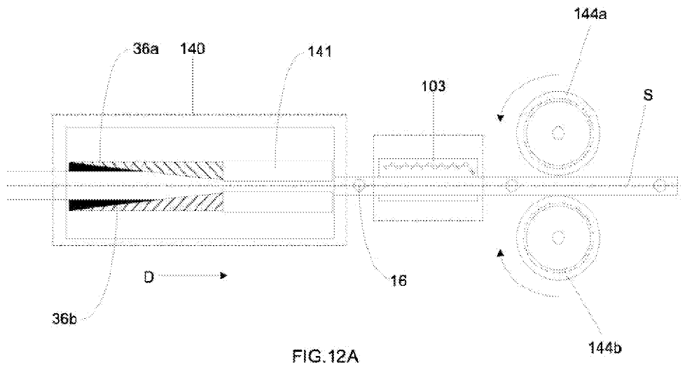

FIGS. 12, 12A in schematic depicts a still further manufacturing process for a paper drinking straw 10 of the invention formed using two separate paper tapes (“ribbons”) including machine elements utilized in the preparation of a paper tape prior to it being formed into a drinking straw with a vertical seam, and without requiring the use of a winding mandrel, but instead the drinking straws 10 are formed using drive friction wheels to pull ribbon through a die, forming it into a drinking straw 10. FIG. 12A provides a more detailed representation of a part of the paper tapes (“ribbons”) at a point in the manufacturing process shown in FIG. 12, (as 140) in particular the part of the process wherein the paper tape 36 having the integrated device 1 providing an anti-outflow capability are formed into wound into a drinking straw 10 according to the invention. In accordance with the depicted process of FIGS. 12, 12A a first paper tape 30 is used to provide discrete flaps 2 which are complexly punched out from the first paper tape 30 using the punch press unit 60, here having a reciprocating punch 60a which has a die 60c which forms flaps 2 which fold downwardly through a guide tube 60 a onto a moving second paper tape 36.

The second paper tape 36 is supplied first to a separate punch press unit 60 which includes a punch roller 62 which rotates and includes a plurality of equally spaced apart punch heads 63 which one coming into contact with the paper tape are pressed against an opposing anvil 64 and thereby cause the formation of an inlet orifices 16 passing through the body of the second paper tape 36. Next, the second paper tape 36 passes in the direction of arrow “D” to an adhesive unit 90 which applies a UV curable (but other adhesive may be used as well, preferably a biodegradable adhesive composition) adhesive which is applied to parts of the paper tape 36, preferably in the region immediately adjacent to one or more of the perforations 16. Subsequently, the second paper tape 36 having regions of adhesive pass downstream and a flap 2 is applied so that it is partially contacted by the adhesive, other parts of which obscure the perforation 16 and thereafter, the flap 2 is bonded to the second paper tape 36, thereby forming the integrated device 1 providing an anti-outflow capability utilizing a laminator unit 100 within which the adhesive material is cured utilizing a suitable source of electromagnetic energy 102, i.e., a UV source. Thereafter, downstream of laminator unit 100, after the flap 2 has been affixed adjacent to perforations 16 such that part of the flap 2 obscures the perforation, in place of a winding mandrel, the drinking straws 10 are formed using a forming die 141 in a die former unit 140 wherein the opposite edges 36a, 36b are brought together to slightly overlap in the longitudinal direction of the paper tape 36, the forming die 141 causing the overlap prior to passing to a suitable source of electromagnetic energy 103, may be used to cure an adhesive which had been previously provided to part of one or both of the edges 36a, 36b and are in the overlapping region downstream of the forming die 141. Movement is facilitated by a pair of counterrotating drive friction wheels 144a, 144b which pull the formed straw outwardly from the forming die 141. As is understood from FIG. 12A, the resultant straw has a vertical seam “S”, in the longitudinal direction of a straw formed thereby, as opposed to a helically configured seam as is formed using a rotating mandrel 50 according to other processes and figures describe elsewhere herein.

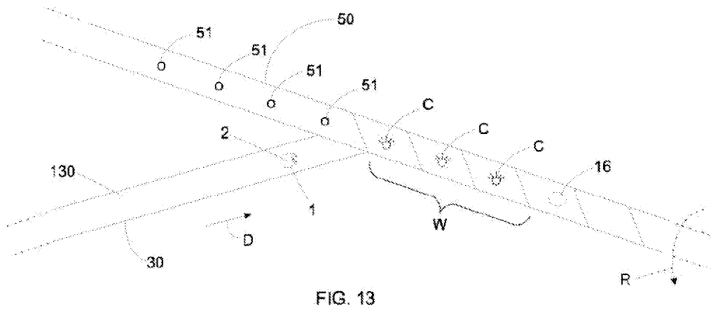

FIG. 13 illustrates a portion of the manufacturing process, which may be considered relevant to embodiments of the invention which include ingestible composition C which is present upon the interior side wall 13a of and ultimately formed paper straw 10 according to the present invention. In this variant of a foregoing process, for that matter of any of the foregoing processes, rather than the insertion or the provision of it and ingestible composition as discussed with regard to any of FIGS. 9, 9A, 9B, 10, 10A, 10B, 10C in which a quantity of the ingestible composition is supplied to the interior 14 of the straw 10 after it is been fully formed, here quantities and ingestible composition C are applied to the interior side wall 13a is it is being wound upon winding mandrel 50. This is made possible by the fact that one or more supply ports 51 may be present as an integral part of the winding mandrel 50, and that during the winding operation of the paper tape 30, quantity of the ingestible composition C is directly supplied from the interior of the winding mandrel 50 via one or more the supply ports 51 and onto the interior side wall 13 and even prior to its separation into discrete sections, that is to say an ultimately formed paper straw 10.

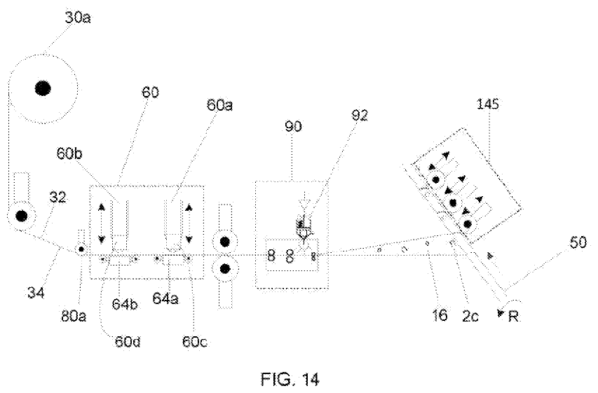

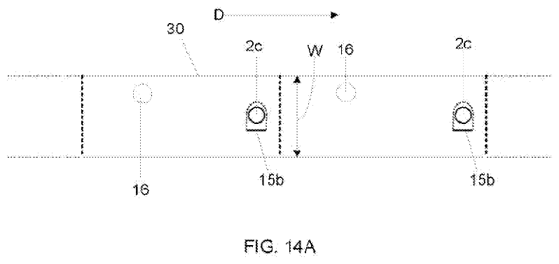

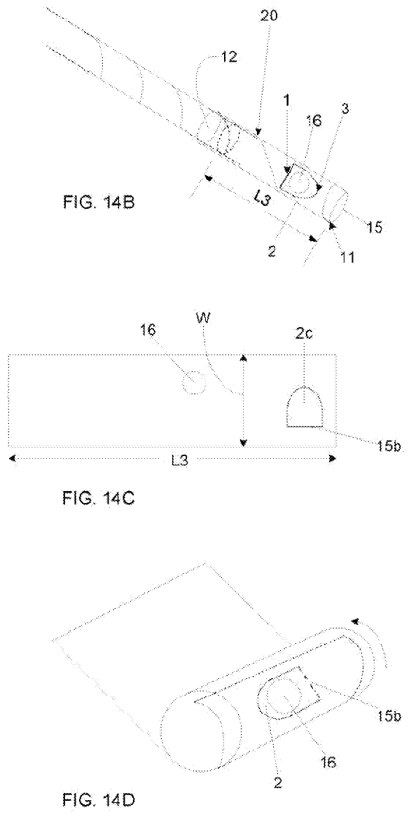

FIGS. 14, 14A-14D provide a schematic of a manufacturing process and other views of an anti-outflow device that could be a retrofit attachment to premanufactured paper or other environmentally friendly or biodegradable drinking straws. This aspect of the invention would be manufactured using one paper tape 30 (“ribbon”) including machine elements for providing a non-separable, hinged (15b) flap (2c) and an orifice 16. In FIG. 14, the manufacturing process would be as follows: paper tape 30 comes off bulk roll 30a, and subsequently passes through tension rollers 80a and enters punch press 60, where it includes a first punch, here a reciprocating punch 60b which has a die 60d which is in the form of an orifice 16 such that when its die 60d is urged against its anvil 64b, it produces the perforation which is the orifice 16, and a second punch, here a reciprocating punch 60a having a die 60c which is in the form of the integral, hinged flap part 15b such that when the die 60c is urged against its anvil 64A it produces the perforated parts 2c of the flap 2 which is seen in better detail on FIG. 14A. Subsequent to the operations of the punch press unit 60, it is to be understood that the flaps 2 are still part of and depend from adjacent parts of the paper tape 30 and the orifices 16 have been formed in the same paper tape and both are formed at desired distances, usually a length L3 along the length of the first paper tape 30. As is more readily understood with regard to FIG. 14, the linear speed and direction of travel, represented by the arrow labeled “D” in FIG. 14 ensures that during the process, the perforation 16 overlay the separable flaps 2a having the flexible flap obscure the corresponding orifice 16. The paper tape enters adhesive supply unit illustrated by the dotted box 90 is provided an adhesive supply unit 94 which supplies a small amount of a suitable adhesive onto parts of the surface of tape, such an adhesive may be a thermally curable, or chemically curable adhesive. Such can be a UV curable adhesive material, or may be any other material which can cause to rapidly cure, harden or viscosify under the influence of a suitable electromagnetic source, such as UV, microwaves, heat, or other source of electromagnetic energy. Alternately, in certain embodiments such adhesive supply unit 90 may be omitted wherein in a subsequent step in mechanical bonding, such as a pressure fit or crimping can be used to at least temporarily affix a flap 2 such that a least a part of it obscures an orifice 16.

In the depicted process of FIG. 14, an adhesive spray applicator 94 applies a suitable adhesive and rollers aligns the paper tape 30 having the orifices 16 and flaps 2 certainly positioned and travel downstream to the forming mandrel 50 where the paper tape 30 is wound upon itself, so that the hinged flap portion is wound inside and the orifice lays over the flap, resulting in an anti-outflow device attachment 20 for pre-manufactured straws. Device attachments are cut with rotary section cutter assembly 145 and can either be crimped or receive end plugs. Again, as with the prior representations, is to be understood that while a reciprocating punch type presses used in the current manufacturing process, other machines and methods for forming flaps 2 and orifices 16 in the paper tapes 30, i.e., a rotary press, a linear stamping press, and the like may be used as well.

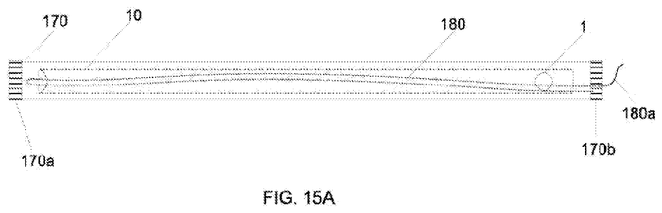

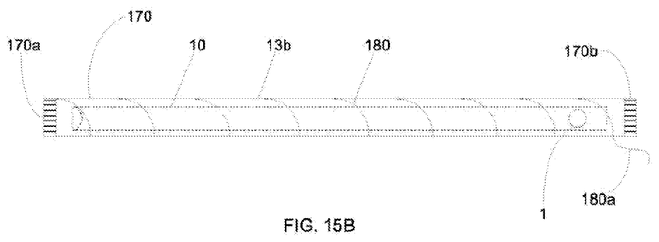

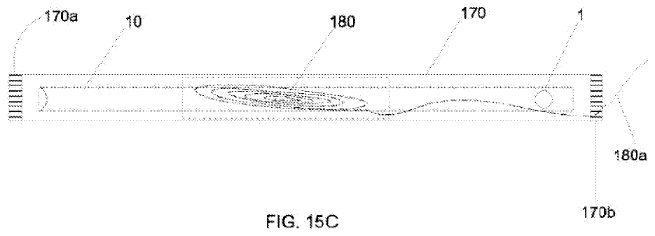

FIGS. 15A, 15B and 15C illustrate further representations of packaged drinking straws 10 of the invention, which include a length of dental floss 180 concurrently provided with a drinking straw 10 according to the invention. In the embodiment of FIG. 15A an outer wrapper 170 comprises two crimped ends 170a, 170b and in cases within this at wrapper 170 the straw 10 and a length of dental floss 180, having one end 180a extending outwardly from one of the crimped ends, here end 170b. The end 180a may be grasped to breach the wrapper 170 and also release the dental floss 180. An alternative embodiment is seen in FIG. 15B, in which is depicted a packaged drinking straw 10 of the invention, as well as a spirally wound length of dental floss 180 which is helically wound about the exterior wall 13b of the straw 10. One end 180a of the dental floss 180 extends outwardly from the wrapper 170; the end 180a may be grasped and pulled to open the wrapper 170 to release the straw 10 and also release the dental floss 180. FIG. 15C depicts a still further embodiment and illustrates a packaged drinking straw 10 of the invention, as well as a flat spiral length of dental floss 180 which is wound in a region adjacent to a part of the straw 10. Similarly, to the prior embodiments, one end 180a of the dental floss 180 extends outwardly from the wrapper 170; the end 180a may be grasped and pulled to open the wrapper 170 to release the straw 10 and also release the dental floss 180.

While the drinking straw 10 disclosed in this application may be formed of any material, including polymer material cellulose-based materials, and in particular paper, which paper can be coated, or otherwise have one or more treated surfaces, and/or contain other non-cellulosic materials, such as colorants, dyestuffs, pigments, adhesives, starches, gums, clays, or for that matter any other materials which find conventional use in the manufacture of drinking straws at the time of the filing of this application, is preferred that at least 80% by weight, more preferably (in order of increasing preference) at least 85%, 86%, 87%, 88%, 89%, 90%, 91%, 92%, 93%, 94%, 95%, 96%, 97%, 98%, 98.5%, 99%, 99.5%, 99.75% and especially preferably 100% by weight of the formed drinking straws of the invention are environmentally friendly or biodegradable materials of construction. For biodegradable materials of construction are those which include a high cellulosic content, or a high starch content, and or based on biodegradable polymeric materials. For example, preferred material for the production of the sidewalls of a drinking straw are largely cellulosic in composition and are preferably a paper-based material. Such paper-based materials may include one or more non-cellulosic components such as an adhesive and optionally a colorant, Inc., dyestuffs, which is also preferably based from a biodegradable material, coming into consideration are soy-based inks commonly known in the printing industry. In a particularly preferred embodiment as noted above, the drinking straws are preferably paper drinking straws which are typically formed by winding long, flat tapes (or ‘ribbons’) substantially formed of paper (optionally coated, such as by wax coating or other which provides some degree of hydrophobicity at the coated surface such that the paper drinking straw does not degrade too quickly, i.e., prior to the consumption of a quantity of a liquid, i.e. a canned beverage or a bottled beverage) which usually includes an added adhesive, preferably a starch-based adhesive or other polymer adhesive (which is also preferably biodegradable, as are many starch-based adhesives) applied to at least a part of at least one surface of the flat paper tapes prior to being wound upon a mandrel in a spiral-like orientation such that there is provided overlaps between succeeding portions of the wound paper tape.

The embodiments of the insertable devices 1 providing an anti-outflow capability particularly as disclosed with reference to FIGS. 3, 3A, 3B, 3C, 3D and 3E, as well as the plug 15 of FIGS. 1, 1A, 1B, and 1C are preferably also formed of environmentally friendly or biodegradable materials of construction.

In a further aspect the invention provides a method facilitating the drinking of a liquid from a container, comprising the use of a drinking straw according to one or more embodiments of drinking straw 10 of the invention described herein, or a drinking straw produced by one or more of the methods of manufacture described herein. The method comprises step of utilizing such a drinking straw by sucking upon the outlet end 12 while the inlet end 11 is positioned within a liquid, preferably a liquid within a container, and especially preferably wherein the liquid is an imbibable beverage. By such a method, persons having reduced ability to form a suction within their buccal cavity may advantageously utilize straws according to the present invention to drink such liquids, particularly beverages.

Subsequently, optionally but very preferably, individual paper drinking straws 10 according to the preferred embodiments of the invention are individually wrapped, preferably also in a similarly advantageously biodegradable wrapper, such as a paper sleeve which is easily breached to dispense the wrapped paper drinking straw 10.

The drinking straws disclosed herein, especially of preferred embodiments, can be manufactured at a relatively advantageous cost and due to the high content of biodegradable and/or environmentally friendly materials used as the materials of construction, as well as, overcomes the growing prejudice against the use of straws from substantially polymeric materials including those which are poorly biodegradable or nonbiodegradable in character (i.e., polyolefins, and copolymers thereof). Further, with accordance to any of the methods described herein, improved straws according to the invention can be manufactured by minor adaptations of existing straw production machinery.

As can be now appreciated from the foregoing specification and the accompanying drawings, the present invention provides improved drinking straws, preferably improved paper drinking straws, and methods for their manufacture, which do not incorporate a ball check and valve seat type of check-valve in their construction, especially the type as illustrated in U.S. Pat. No. D332,198.

1. A drinking straw providing an anti-outflow capability, wherein in the drinking straw is formed substantially of a cellulosic material and wherein the drinking straw and the device providing the anti-outflow capability is formed using environmentally friendly or biodegradable materials of construction.

2. The drinking straw of claim 1, wherein the device providing the anti-outflow capability is a flexible flap having a fixed end affixed to an interior surface of a sidewall of the drinking straw, and a part of the flexible flap obscuring an inlet orifice passing through the sidewall adjacent to the flexible flap and forming a liquid tight seal when a reduced pressure condition exists within the interior flow passage of the drinking straw.

3. The drinking straw of claim 1, wherein the device providing the anti-outflow capability is a plug having a flexible flap, the plug inserted in an inlet end of the drinking straw and forming a liquid tight seal therewith, the flexible flap having a part obscuring an inlet orifice passing through the sidewall adjacent to the flexible flap and forming a liquid tight seal when a reduced pressure condition exists within the interior flow passage of the drinking straw.

4. The drinking straw of claim 1, wherein the device providing the anti-outflow capability is a crimp at the inlet end of the drinking straw having depending therefrom a flexible flap, the crimp forming a liquid tight seal at the inlet end of the straw, the flexible flap having a part obscuring an inlet orifice passing through the sidewall adjacent to the flexible flap and forming a liquid tight seal when a reduced pressure condition exists within the interior flow passage of the drinking straw.

5. The drinking straw of claim 1, wherein the drinking straw is formed substantially from one or more helically wound tapes.

6. The drinking straw of claim 1, wherein the drinking straw has a vertical seam.

7. A method of forming a drinking straw of claim 1, the method comprising the steps of:
providing a perforation through a paper tape;
providing a flap to the paper tape in the proximity of the perforation;
bonding the flap to the paper tape such that, in use, a portion of the flexible flap obscures the perforation of the drinking straw formed from the paper tape.

8. The method of claim 7, wherein the flap is bounded to the paper tape via a crimp at an end of the drinking straw.

9. A method of forming a drinking straw of claim 1, the method comprising the steps of:
providing a perforation through a paper tape;
forming a drinking straw from the paper tape such that the perforation is in the region of an inlet end,
inserting a plug having a depending flexible flap into the inlet end such that, in use, a portion of the flexible flap obscures the perforation of the drinking straw formed from the paper tape.

10. A method forming a drinking straw of claim 1, the method comprising the steps of:
providing a perforation through a first paper tape;
forming a detachable flexible flap from a second tape;
providing the flexible flap to the first paper tape such that a part of the flexible flap obscures the perforation,
bonding a portion of the flexible flap to the first paper tape in the region adjacent to the perforation;
optionally removing the second tape from the first paper tape, and separating the bonded flexible flap from the second tape;
forming the drinking straw from the first paper tape and optionally the second paper tape.

11. The method of claim 10, wherein the second tape is separated from the first paper tape and from the bonded flexible flap, prior to formation of the drinking straw.

12. The drinking straw of claim 1, which further comprises an ingestible composition.

13. The drinking straw of claim 12, wherein the ingestible composition is a pre-formed body of the ingestible composition.

14. The drinking straw of claim 12, wherein the ingestible composition is an ingestible material which provides a nutritious, flavoring, medical, therapeutic, or other organoleptic perception or benefit to a person utilizing the straw.

15. The drinking straw of claim 12, wherein the ingestible composition is selected from:
pharmaceutical preparations, nutraceutical preparations, confectionery compositions, natural sweeteners, artificial sweeteners, and flavoring compositions.

16. The drinking straw of claim 12, which further comprises a breachable element.

17. A breachable package containing the drinking straw of claim 1, and a length of dental floss.
